(19) United States
(12) Patent Application Publication
(10) Pub. No.: US 2024/0424331 A1
(43) Pub. Date: Dec. 26, 2024

(54) Permanent Fire Sprinkler Discharge Filtration System

(71) Applicant: Robert M Sanchez, La Habra, CA (US)

(72) Inventor: Robert M Sanchez, La Habra, CA (US)

(21) Appl. No.: 18/672,965

(22) Filed: May 23, 2024

Related U.S. Application Data
(60) Provisional application No. 63/522,921, filed on Jun. 23, 2023.

(51) Int. Cl. A62C 35/68; C02F 1/00; C02F 103/00

(52) U.S. Cl. CPC A62C 35/68; C02F 1/004; C02F 2103/003

(57) ABSTRACT

A Fire Sprinkler System Discharge Filter System (FSSDFS) includes a strainer and filter. The strainer is connected through a valve to a sprinkler system riser. Strained waste water is filtered by the filter and is suitable for general release. Filtered was is directly released from the filter with no further filtering. The FSSDFS is a low cost system suitable to permanently connect to a sprinkler system to avoid costs for delivering, connecting, operating, disconnecting, and returning a mobile system.

### CROSS-REFERENCE TO RELATED APPLICATIONS

The present application claims the priority of U.S. Provisional Patent Application Ser. No. 63/522,921 filed Jun. 23, 2023, which application is incorporated in its entirety herein by reference.

### BACKGROUND OF THE INVENTION

The present invention relates to containment of stagnant, polluted, and/or contaminated liquids and in particular to containment, filtration, and discharge of the stagnant, polluted, and/or contaminated water released from sprinkler systems during periodic draining.

Although the water entering a sprinkler system is generally potable water, there are subsequent effects which may drastically reduce the quality of the water in such systems. This water often remains in the sprinkler system for one or more years becoming contaminated, stagnant, and stale, having a very foul odor. Black iron pipe is generally used since it is more economical than potable piping, but unfortunately black iron pipe is prone to rusting which contaminates water residing in the black iron pipe. Also, new black iron pipe has an oil coating to protect it from rusting between manufacture and installation. This oil coating also contaminates the water.

In addition to the effects of using black iron pipe, the water residing in fire sprinkler lines in most buildings is contaminated with pollutants including chemicals, toxins, and disease causing agents. Nitrates, poly-phosphates and other corrosive inhibitors, as well as fire suppressants and anti-freeze may be added to the sprinkler water system as well. Also, between sprinkler system flushes, the water residing in the pipes may accumulate iron, magnesium, lead, copper, nickel, and zinc. This water generally becomes toxic and contains living and dead bacteria and breakdown products from chlorination. This may result in a significant Biochemical Oxygen Demand (BOD) problem. The BOD is a measure of the amount of oxygen required for the biochemical degradation of organic material in a water sample.

Such sprinkler systems are common in both industrial and commercial building. Because of the obvious safety issues with reliance on a sprinkler system, periodic testing of sprinkler systems is required by the National Fire Protection Association (NFPA) 25 standards (NFPA13). Such tests generally include draining and flushing stagnant, polluted, and/or contaminated water from the sprinkler systems and generally results in the stagnant, polluted, and/or contaminated water run off into the storm drains. The sprinkler tests include a Quarterly Fire Sprinkler Test, a Quarterly Drain Test, a Yearly Flow Test, a 5-Year Fire Sprinkler Certification Test, and a Flush Test for all new fire sprinkler system installations.

The Quarterly Fire Sprinkler Test includes placing an intentionally broken sprinkler head at the end of a sprinkler pipe to simulate an actual fire sprinkler activation. Fire sprinklers are designed to include an inspector's test valve attached with one inch piping leading to the outside of the building. Once the inspector's test valve is opened, it detects the broken sprinkler head and simulates an actual fire sprinkler activation. The inspector attempts to confirm that the local bell for the building goes off and also that a monitoring company has received a signal indicating that the sprinkler system has been activated. Stagnant, polluted, and/or contaminated water is released during this test and generally runs off into storm drains leading to streams, lakes and beaches.

The Quarterly Drain Test is required by the NFPA and insurance companies and requires opening a drain valve at a sprinkler riser for a few seconds and then closing the drain valve quickly to see how quickly a pressure gauge returns to normal pressure. The Quarterly Drain Test assures that a main valve out in the street is open and has not been accidentally closed by a public works employee. Again, the stagnant, polluted, and/or contaminated water released during this test generally runs off into the storm drains leading to streams, lakes and beaches.

In addition to periodic testing, in the course of a tenant improvement project, the standard procedure for a Fire Sprinkler Contractor is to drain the sprinkler system. However, some trapped water remains in the lines and is later emptied into, for example, a 55 gallon drum with wheels. A serviceman dumps the water, which often includes stagnant, polluted, and/or contaminated water, to the curb which leads to the storm drains leading to streams, lakes and beaches.

The release of contaminated water into storm drains not only causes sickness, but sometimes even deaths in humans, animals and aquatic life. This water pollution problem, along with other industrial wastes, has contributed to rendering several recreational areas, streams, lakes and beaches completely contaminated and unsafe.

The “Federal Clean Water Act” requires that the fire sprinkler waste water flushed from a sprinkler system be directed to a sewer leading into a water treatment plant. Under no circumstances should fire sprinkler water containing high levels of pollutants be allowed to enter the storm drains. The illegal practice of allowing contaminated fire sprinkler water to enter the storm drains has been ongoing for decades, since fire sprinklers were first introduced to the public, in spite of stiff fines and penalties from the Water Districts. Because of the present difficulty in satisfying the Federal Clean Water Act, sprinkler system tests are still conducted which allow the polluted water to enter storm drains.

Although some municipalities have started requiring containment of this flushed polluted water when performing these tests, known apparatus and methods have failed. Some have suggested running hoses connected to the FDC directly to a sewer line. Unfortunately, the sewer lines are often blocks away from the FDC and this procedure would require traffic control since the sewer plates are located in the middle of the streets. Also, the fire inspectors would have to be present at the street sewer plate to witness the clear water indicating that the FDC has been flushed and cleared.

Another proposed method is to have a waste management disposal company collect the water and then transfer it to a water treatment plant. But to coordinate with a fire inspector and a waste management disposal company is problematic. Because of the fire department inspector's heavy workload, they are often late for these scheduled tests. The added cost to contract a waste management disposal company, and have them also wait for the inspector, would have to be passed on to the business owner and would be cost prohibitive.

U.S. Pat. No. 7,438,820 filed by Applicant describes a prior art waste water filtering system temporarily connected to a Fire Department Connection (FDC). The system includes a chemically selective sponge to capture, for example, oil, and destroy bacteria. The chemically selective sponge has been found to be unnecessary, adds cost, and reduces flow rate. The system in the '820 patent further requires a cart, a pump, wiring, and an on/off switch, adding substantial cost which may be feasible for a large facility with multiple sprinkler systems, but not for a building with a single sprinkler system. Filters to replace the chemically selective sponge are available, but known filters have passed some unfiltered waste water avoiding an internal filter element and releasing the unfiltered waste water from the filter outlet. Because regulations do not allow any unfiltered waste water to be released, and a new filter element cartridge is needed to prevent the release of the unfiltered waste water.

### BRIEF SUMMARY OF THE INVENTION

The present invention addresses the above and other needs by providing a low cost, installed, Fire Sprinkler System Discharge Filter System (FSSDFS). The FSSDFS includes a strainer and filter. The strainer is connected through a valve to a sprinkler system riser. Strained waste water is filtered by the filter element cartridge and is suitable for general release.

In accordance with one aspect of the invention, there is provided an FSSDFS not requiring a chemically selective sponge, thereby reducing cost and increasing flow rate.

In accordance with another aspect of the invention, there is provided a low cost FSSDFS. The FSSDFS may be permanently installed significantly reducing service fee for delivering, connecting, operating, disconnecting, and returning a mobile system.

In accordance with yet another aspect of the invention, there is provided an FSSDFS having a unique filter interface. The filter interface prevents installation of filter elements which do not satisfy government requires which may result in substantial fines.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a prior art Fire Sprinkler System Discharge Filter System (FSSDFS).

FIG. 2 shows an FSSDFS according to the present invention.

FIG. 3 shows a side view of a filter used in the FSSDFS according to the present invention.

FIG. 3A shows a top view of the filter used in the FSSDFS according to the present invention.

FIG. 4 shows an exploded view of the filter used in the FSSDFS according to the present invention.

FIG. 5 shows a method for using the FSSDFS according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement, or typically within 10 percent of a stated value.

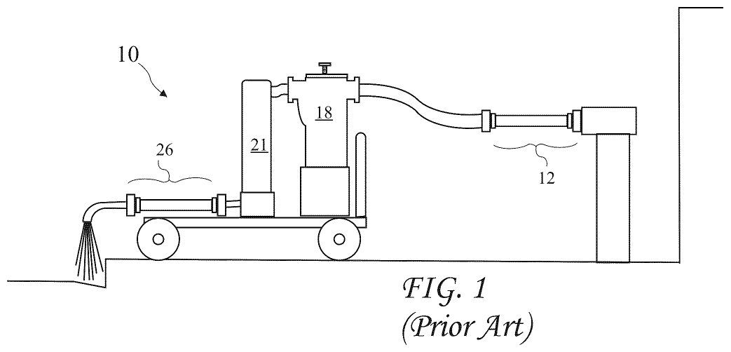

A prior art Fire Sprinkler System Discharge Filter System (FSSDFS) 10 according to the present invention is shown in FIG. 1. The FSSDFS 10 includes a sight tube 12, strainer 18, filter 21, and encased chemically selective polymer 26. The encased chemically selective polymer 26 adds significant cost and has been found to be unnecessary.

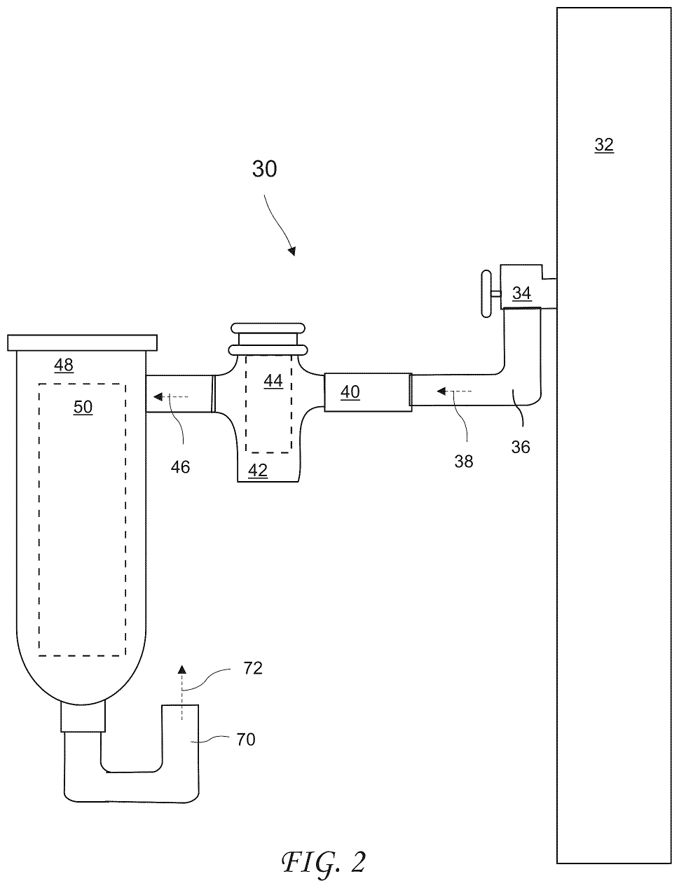

An FSSDFS 30 according to the present invention is shown in FIG. 2. The FSSDFS 30 may be permanently connected to a fire sprinkler system riser 32 thereby reducing service fees required for delivering, connecting, operating, disconnecting, and returning a mobile system. A valve 34 is connected to the riser 32 to release waste water 38 into the FSSDFS 30 through a pipe 36 connecting the valve 34 to a strainer 42. A sitetube 40 may be connected between the valve 34 and strainer 42, or after the strainer 42 to observe the waste water 38. The strainer 42 includes a strainer element 44, for example, a less than 40 micron strainer element or about a 40 micron strainer element. Strained liquid 46 from the strainer 42 enters a filter 48 which, for example, includes a less than a 10 micron filter element 50 or about a 10 micron filter element 50, and preferably a polypropylene micro fiber filter element 50. Filtered water 72 is released from the filter 48 through an outlet pipe 70. The filter 48 may include features preventing use of an incorrect filter element 50 which will not satisfy government standards, for example the Federal Clean Water Act.

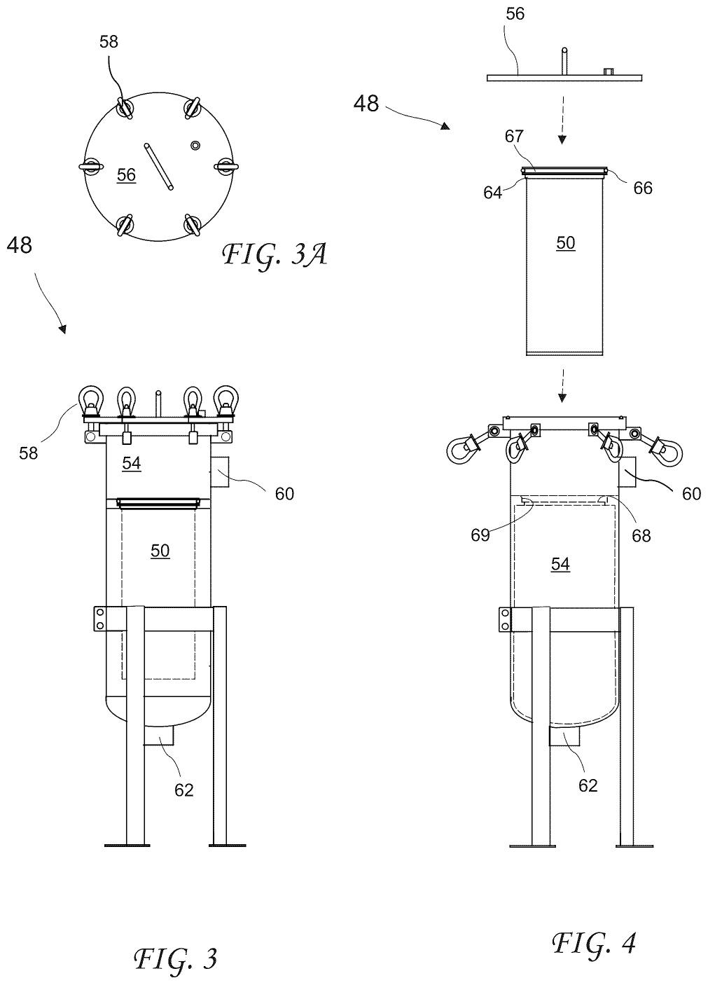

FIG. 3 shows a side view of the filter 48, FIG. 3A shows a top view of the filter 48, and FIG. 4 shows an exploded view of the filter 48. The filter 48 includes a body 54 and removable lid 56. The body 54 includes an inlet 60 receiving the strained flow 46 from the strainer 42, and an outlet 62 providing the filtered flow 72 to the outlet pipe 70. The filter 50 seats against a shelf 68 inside the body 54.

The filter element 50 includes an O-Ring 66 seated in a circumferential groove 67 in a flared top 64 of the filter element 50. The O-Ring 66 resides in the groove 67 and seals against a riser 69 comprising a circumferential opening above the shelf 68.

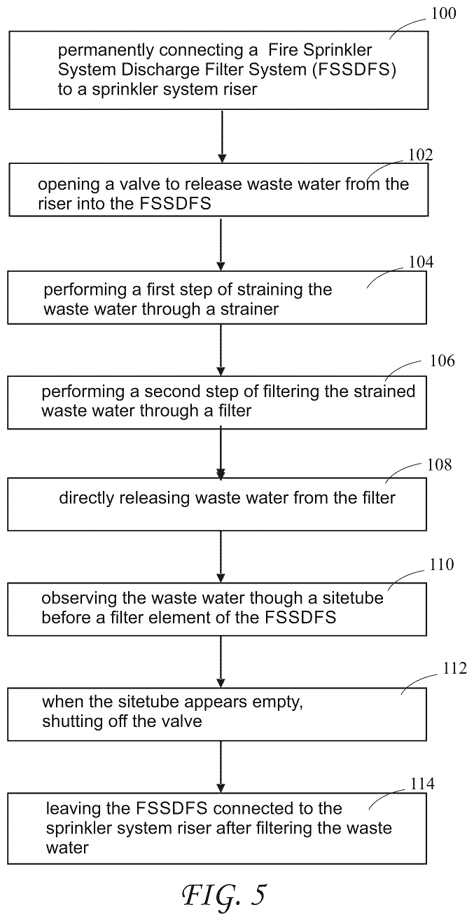

FIG. 5 shows a method for using the FSSDFS 30. The method includes permanently connecting the FSSDFS to a sprinkler system riser at step 100, opening a valve to release waste water from the riser into the FSSDFS at step 102, performing a first step of straining the waste water through a strainer at step 104, performing a second step of filtering the strained waste water through a filter at step 106, directly releasing waste from the filter at step 108, observing the waste water though a sitetube before a filter element of the FSSDFS at step 110, when the sitetube appears empty, shutting off the valve at step 112, and leaving the FSSDFS connected to the sprinkler system riser after filtering the waste water at step 114.

While the invention herein disclosed has been described by means of specific embodiments and applications thereof, numerous modifications and variations could be made thereto by those skilled in the art without departing from the scope of the invention set forth in the claims.

I claim:

1. A Fire Sprinkler System Discharge Filter System (FSSDFS) comprising:
a valve configured to connect to a sprinkler system to receive raw waste water;
a strainer in fluid communication with the valve to receive the raw waste water from the valve and release strained waste water;
a filter in fluid communication with the strainer to receive the strained waste water from the strainer and release filtered waste water; and
an outlet pipe connected directly to the filter to receive the filtered waste water and to release the filtered waste water for disposal directly into storm drains or receiving waters.

2. The FSSDFS of claim 1, further including a sitetube residing serially with the strainer and filter between the valve and the outlet pipe.

3. The FSSDFS of claim 1, wherein:
the strainer receives the untreated waste water directly from the valve; and
the filter receives the strained waste water directly from the strainer.

4. The FSSDFS of claim 3, wherein the filter releases the filtered water satisfying the Federal Clean Water Act.

5. The FSSDFS of claim 1, wherein the strainer element is a 40 micron or less strainer element.

6. The FSSDFS of claim 1, wherein the strainer element is about a 40 micron strainer element.

7. The FSSDFS of claim 1, wherein the filter element is a 10 micron or less strainer element.

8. The FSSDFS of claim 1, wherein the filter element is about a 10 micron strainer element.

9. The FSSDFS of claim 1, wherein the filter element is polypropylene micro fiber filter element.

10. The FSSDFS of claim 1, wherein:
the strainer element is a 40 micron or less strainer element;
the filter element is a 10 micron or less strainer element; and
the filter element is polypropylene micro fiber filter element.

11. The FSSDFS of claim 1, wherein:
the filter includes a filter body and a removable filter lid;
the filter body includes an internal shelf;
the shelf includes a circumferential opening;
a removable filter element resides inside the filter body;
the filter element includes a flared top for seating against the step;
the flared top includes a circumferential groove; and
an O-Ring resides in the circumferential groove and seats against the shelf then the filter element is seated in the filter body.

12. The FSSDFS of claim 1, wherein the circumferential opening is step.

13. A Fire Sprinkler System Discharge Filter System (FSSDFS) comprising:
a valve configured to connect to a sprinkler system to receive raw waste water;
a strainer in fluid communication with the valve to receive the raw waste water from the valve and release strained waste water;
a 40 micron strainer element residing in the strainer;
a filter in fluid communication with the strainer to receive the strained waste water from the strainer and release filtered waste water;
a 10 micron filter element residing on a circumferential shelf inside the filter;
an O-Ring resided in a groove in a top of the filter element and seals against a riser rising from the circumferential shelf; and
an outlet pipe connected to the filter to receive the filtered waste water from the filter and to release the filtered waste water for disposal into storm drains or receiving waters.

14. A method comprising:
permanently connecting the FSSDFS to a sprinkler system riser;
opening a valve to release waste water from the riser into the FSSDFS; performing a first step of straining the waste water through a strainer;
performing a second step of filtering the strained waste water through a filter;
directly releasing water from the filter into storm drains or receiving waters;
observing the waste water through a sitetube before the filter;
when the sitetube appears empty, shutting off the valve; and
leaving the FSSDFS connected to the sprinkler system riser after filtering the waste water.

15. The method of claim 14, wherein directly releasing water from the filter comprises directly releasing water from the filter into a storm drain.

16. The method of claim 14, wherein directly releasing water from the filter comprises directly releasing water from the filter satisfying the Federal Clean Water Act.

17. The method of claim 14, wherein straining the waste water through a strainer comprises straining the waste water through a 40 micron or less strainer.

18. The method of claim 14, wherein filtering the strained waste water through a filter comprises filtering the strained waste water through a 10 micron or less filter.

19. The method of claim 14, wherein:
straining the waste water through a strainer comprises straining the waste water through a 40 micron or less strainer; and
filtering the strained waste water through a filter comprises filtering the strained waste water through a 10 micron or less filter.

20. The method of claim 14, wherein:
performing no additional processing between the sprinkler system riser and the strainer;
performing no additional processing between the strainer and the filter; and
performing no additional processing between the filter and the directly releasing water from the filter into the storm drains or the receiving waters.
